(19) United States
(12) Patent Application Publication
(10) Pub. No.: US 2014/0249874 A1
(43) Pub. Date: Sep. 4, 2014

(54) FARM WORK SUPPORT METHOD AND FARM WORK SUPPORT APPARATUS

(71) Applicant: FUJITSU LIMITED, KAWASAKI-SHI (JP)

(72) Inventor: Masafumi ASAI, Yokohama (JP)

(73) Assignee: FUJITSU LIMITED, KAWASAKI-SHI (JP)

(21) Appl. No.: 14/276,308

(22) Filed: May 13, 2014

Related U.S. Application Data
(63) Continuation of application No. PCT/JP2012/050041, filed on Jan. 4, 2012.

(51) Int. Cl. G06Q 10/04; G06Q 50/02

(52) U.S. Cl. CPC G06Q 10/04; G06Q 50/02
USPC 705/7.11

(57) ABSTRACT

A farm work support method executed by a computer includes calculating a forecast harvest date of a first cultivation of crops based on result values of a weather condition from a start date of the first cultivation to a current day stored in a storage unit, and forecast values of the weather condition after the current day stored in the storage unit, and calculating a forecast harvest date of a second cultivation of crops based on the forecast values after the current day stored in the storage unit; and determining the current day as a start date of the second cultivation if an interval between the forecast harvest date of the first cultivation and the forecast harvest date of the second cultivation has the number of days greater than or equal to a predetermined number of days.

### CROSS-REFERENCE TO RELATED APPLICATIONS

This application is a continuation application of International Application PCT/JP2012/050041 filed on Jan. 4, 2012 and designated the U.S., the entire contents of which are incorporated herein by reference.

### FIELD

The disclosures herein generally relate to a farm work support method and a farm work support apparatus.

### BACKGROUND

Crops are planted following cultivation calendars that are customized for harvest times of the respective breeds of crops.

On the other hand, there are crops or crops for processing that are difficult to preserve due to the high cost of preservation of the crops after harvest or the difficulty in quality preservation. For such crops and crops for processing and the like, there are market needs for a stable supply throughout the year.

Thereupon, farmers carry out actual cultivations by making a schedule including multiple planting times that have respective target harvest times. For example, cultivations are carried out by shifting cultivation start timings multiple times to shift the harvest times.

### RELATED-ART DOCUMENTS

### Patent Documents

[Patent Document 1] Japanese Laid-open Patent Publication No. 2010-86242

However, the growth of crops is greatly influenced by weather conditions. Also, weather conditions are not necessarily stable year by year. Therefore, the intervals between harvest times may be shorter or longer than the initial schedule.

Consequently, this makes it difficult to secure enough personnel for harvest times, and/or produce skewed market conditions, which hinder a stable business of farming.

### SUMMARY

According to at least one embodiment of the present invention, a farm work support method executed by a computer includes calculating a forecast harvest date of a first cultivation of crops based on result values of a weather condition from a start date of the first cultivation to a current day stored in a storage unit, and forecast values of the weather condition after the current day stored in the storage unit, and calculating a forecast harvest date of a second cultivation of crops based on the forecast values after the current day stored in the storage unit; and determining the current day as a start date of the second cultivation if an interval between the forecast harvest date of the first cultivation and the forecast harvest date of the second cultivation has the number of days greater than or equal to a predetermined number of days.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a schematic view illustrating an example of a cultivation schedule of cabbage M according to an embodiment of the present invention;

FIG. 2 is a schematic view illustrating an example of a relationship between planting dates and forecast harvest dates of cabbage M;

FIG. 3 is a schematic view illustrating an example of a relationship between planting dates and the number of days required until harvest for cabbage M;

FIG. 4 is a schematic view illustrating an example of a calculation method of a forecast harvest date according to an embodiment of the present invention;

FIG. 5 is a schematic view illustrating an example of a determination method of planting dates of cultivations in year A;

FIG. 6 is a schematic view illustrating planting dates and forecast harvest dates of cultivation 2 and cultivation 3 in year A;

FIG. 7 is a schematic view illustrating an example of a determination method of planting dates of cultivations in year B;

FIG. 8 is a schematic view illustrating planting dates and forecast harvest dates of cultivation 2 and cultivation 3 in year B;

FIG. 9 is a schematic view illustrating an example of a configuration of a farm work support system according to an embodiment of the present invention;

FIG. 10 is a schematic view illustrating an example of a hardware configuration of a farm work support apparatus according to an embodiment of the present invention;

FIG. 11 is a schematic view illustrating an example of a functional configuration of a farm work support apparatus according to an embodiment of the present invention; and

FIG. 12 is a flowchart illustrating an example of a determination process of planting dates.

### DESCRIPTION OF EMBODIMENTS

In the following, embodiments of the present invention will be described with reference to the drawings. In the present embodiment, cabbage of a breed M is adopted as a concrete example of crops. The cabbage of the breed M is referred to as the “cabbage M” below.

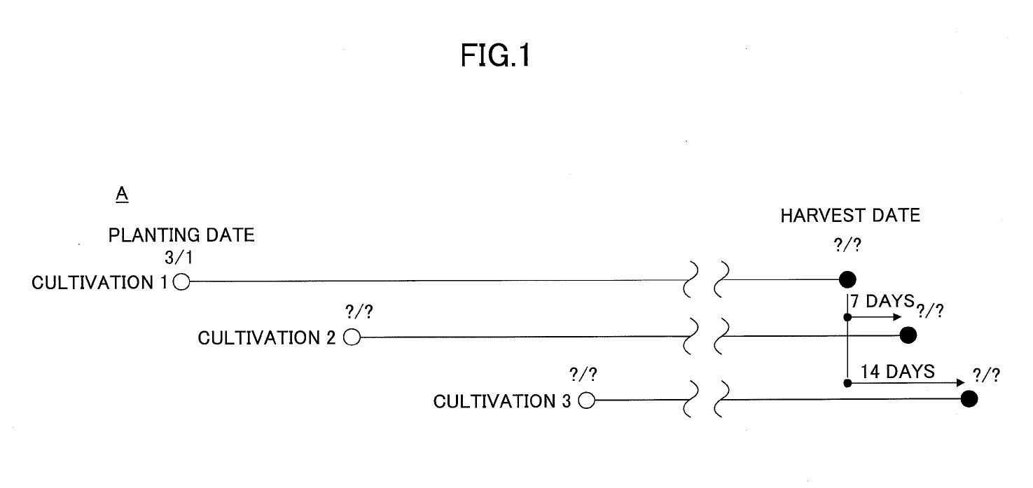

FIG. 1 is a schematic view illustrating an example of a cultivation schedule of the cabbage M according to the present embodiment. In a cultivation schedule A illustrated in FIG. 1, three cultivations of the cabbage M, or cultivations 1-3, are planned that have planting dates shifted from each other. Note that “cultivation” is a unit of work including various labor tasks commonly carried out for the same breed of crops that is started with preparation of the cultivation and completed with the harvest of the crops in the present embodiment. Note that planting dates are designated by white circles, and harvest dates are designated by black circles in FIG. 1.

FIG. 1 illustrates the content of cultivation plan A when it is being planned. As can be seen in FIG. 1, what are determined at the planning time are the planting date of cultivation 1, the interval between the harvest date of cultivation and the harvest date of cultivation 2, and the interval between the harvest date of cultivation 1 and the harvest date of cultivation 3. Namely, the planting date of cultivation 1 is set on March 1st.

Also, the interval between the harvest date of cultivation 1 and the harvest date of cultivation 2 is set to seven days. The interval between the harvest date of cultivation 1 and the harvest date of cultivation 3 is set to 14 days. Note that an interval between the harvest date of a cultivation and the harvest date of another cultivation will be called a “harvest interval” below.

In the present embodiment, assuming such circumstances, a method will be described that determines planting dates of cultivations 2 and 3 so that the planting dates make likelihood high for intervals of forecast harvest dates of the cultivations being close to the harvest intervals in cultivation plan A. The forecast harvest date is a forecast value of a harvest date.

In the present embodiment, forecast harvest dates of cultivations are calculated by using effective accumulated temperature, which is an example of a weather condition. It is assumed for the cabbage M that a day having the effective accumulated temperature greater than or equal to 700° C. day is determined as the harvest date. The effective accumulated temperature is an accumulated value of temperatures of the days that contribute growth. For example, for the cabbage M, if the average temperature of a day is over 5° C., the degrees over 5° C. are counted for the growth. If the average temperature of a day is 12° C., 12-5=7° C. is added to the effective accumulated temperature as contribution to the growth. An average temperature less than or equal to 5° C. is not added to the effective accumulated temperature. Note that ° C. day is a unit of the effective accumulated temperature in terms of the average temperature within a day.

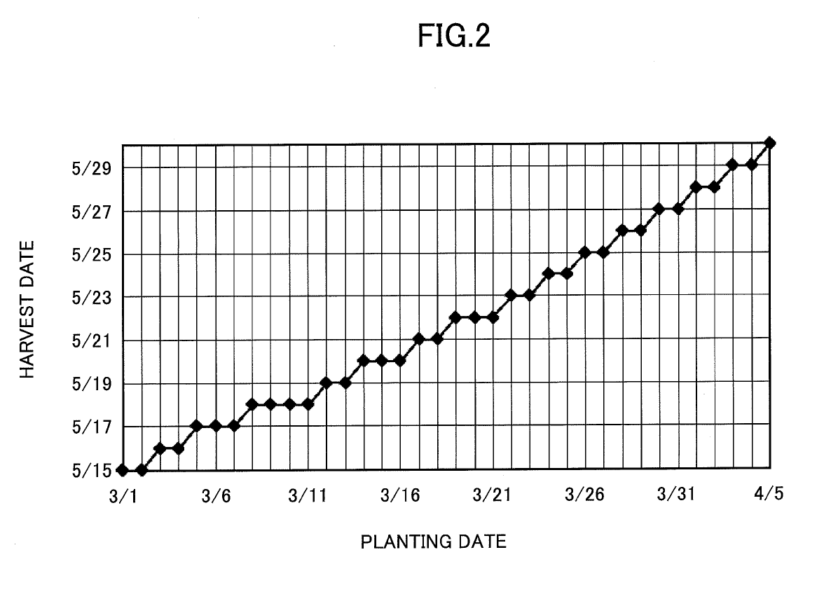

Actual average temperatures of future days are unknown, and when to reach the effective accumulated temperature is also unknown. Therefore, forecast values are used for the average temperatures of future days. In the present embodiment, for example, normal yearly values of the average temperatures of days in a region where cultivation of the cabbage M is carried out are used as forecast values. Based on the normal yearly values, for example, a relationship between planting dates and forecast harvest dates is obtained as illustrated in FIG. 2.

FIG. 2 is a schematic view illustrating an example of a relationship between planting dates and forecast harvest dates of the cabbage M. In FIG. 2, the horizontal axis represents planting dates, and the vertical axis represents harvest dates. A harvest date can be forecasted from a planting date based on this relationship.

Similarly, the number of days required until the harvest can be calculated for a planting date of the cabbage M, based on normal yearly values of average temperatures and the effective accumulated temperature of the cabbage M.

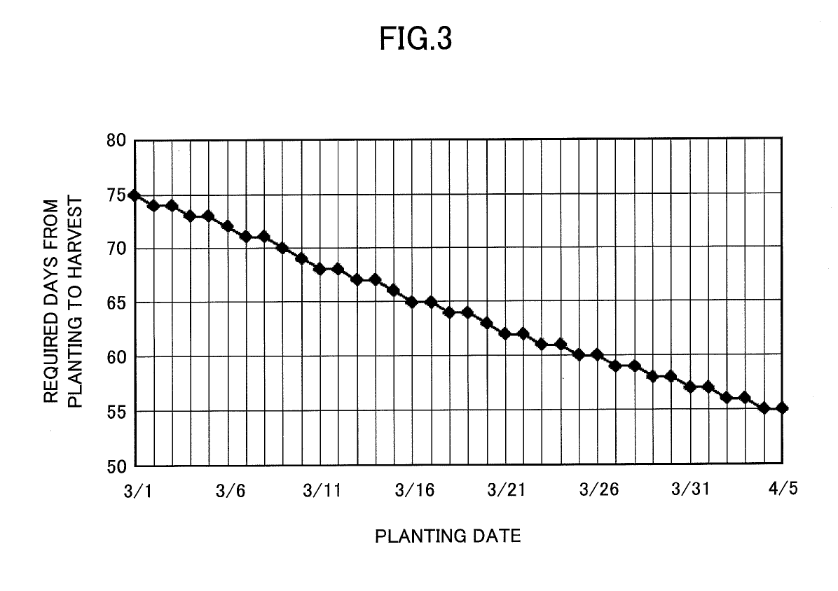

FIG. 3 is a schematic view illustrating an example of a relationship between planting dates and the number of days required until harvest for the cabbage M. In FIG. 3, the number of days required until harvest becomes less with later planting dates. This is because the season relating to cultivation plan A is a period where the rate of upward change of the effective accumulated temperature increases day by day. In other words, it is a period where the number of days required to achieve the effective accumulated temperature decreases day by day.

As can be seen in FIGS. 2-3, if day-to-day temperatures change as normal yearly values every year, a planting date can be determined by setting a harvest date. However, a weather condition cannot be the same every year, and growth of planted crops is affected by temperatures of a specific year.

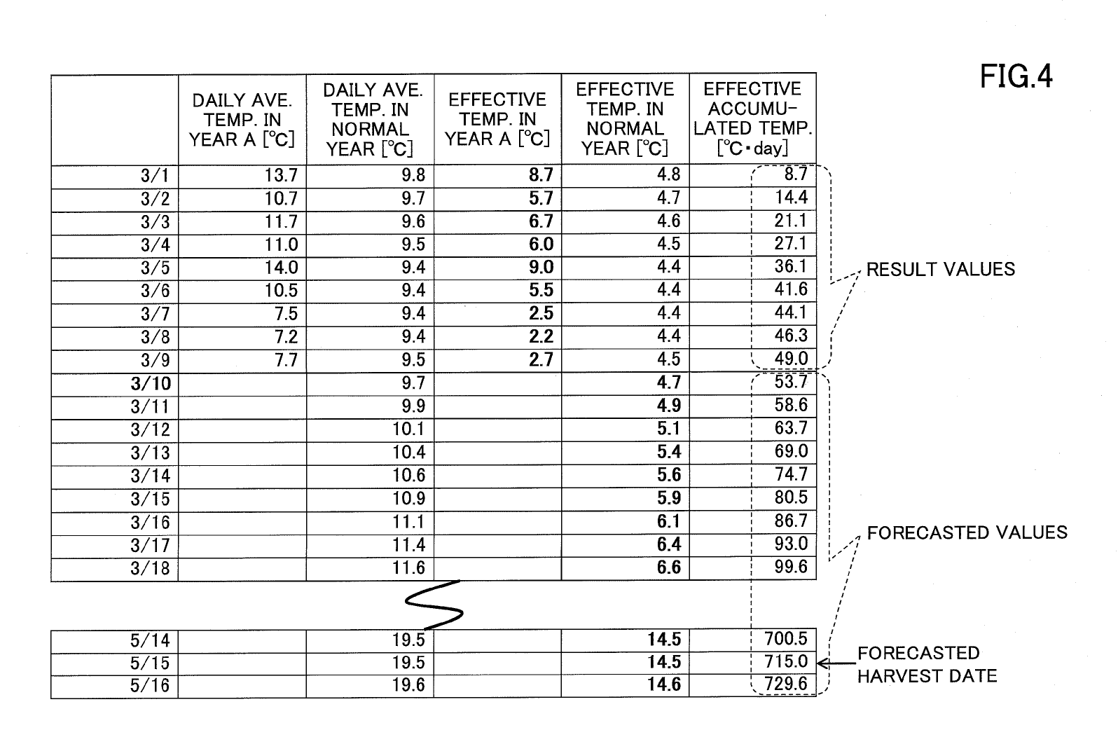

Therefore, a forecast harvest date is calculated as follows in the present embodiment. FIG. 4 is a schematic view illustrating an example of a calculation method of a forecast harvest date according to the present embodiment. FIG. 4 illustrates daily average temperatures in year A, daily average temperatures in the normal year, effective temperatures in year A, effective temperatures in the normal year, and effective accumulated temperatures for days after March 1st that is set as the cultivation start date, or the planting date, of cultivation 1.

Daily average temperatures in year A are result values of average temperatures of days in year A. Daily average temperatures in the normal year are normal yearly values of average temperatures of days. Effective temperatures in year A are effective temperatures of days for the cabbage M. In the present embodiment, an effective temperature in year A is calculated by an average temperature in year A—5. Effective temperatures in the normal year are normal yearly values of effective temperatures of days for the cabbage M. In the present embodiment, an effective temperature in the normal year is calculated by an average temperature in the normal year—5. Effective accumulated temperatures are accumulated values of the effective temperatures in year A or the effective temperatures in the normal year. Namely, up to a day when a forecast harvest date is calculated, the effective temperatures in year A are accumulated, and for days following that day, the effective temperature in the normal year are accumulated.

In FIG. 4, March 10th in year A is assumed to be the day for calculating a forecast harvest date. Also, the forecast harvest date is calculated for cultivation 1 whose planting date is March 1st.

First, the effective temperatures in year A are accumulated for days before the day, or from March 1st to March 9th, to calculate the effective accumulated temperature. After March 10th, effective temperatures in the normal year are accumulated, added to the previously calculated effective accumulated temperature to calculate the effective accumulated temperature. Consequently, in the example in FIG. 4, it is forecasted that the effective accumulated temperature reaches 700° C. day on May 14th. Therefore, the next day, or May 15th, is determined as the forecast harvest date of cultivation 1.

Based on the above calculation method of a forecast harvest date, forecast harvest dates of cultivation 1, cultivation 2, and cultivation 3 are periodically calculated after the planting date of cultivation 1, namely, after March 1st, in the present embodiment. In the present embodiment, calculation of forecast harvest dates is executed every day. The planting date of cultivation 2 is determined to be a day that makes the interval between the forecast harvest dates of cultivation 1 and cultivation 2 be longer than or equal to seven days, which is the harvest interval between cultivation 1 and cultivation 2 in cultivation plan A. Similarly, the planting date of cultivation 3 is determined to be a day that makes the interval between the forecast harvest dates of cultivation 1 and cultivation 3 be longer than or equal to 14 days, which is the harvest interval between cultivation 1 and cultivation 3 in cultivation plan A.

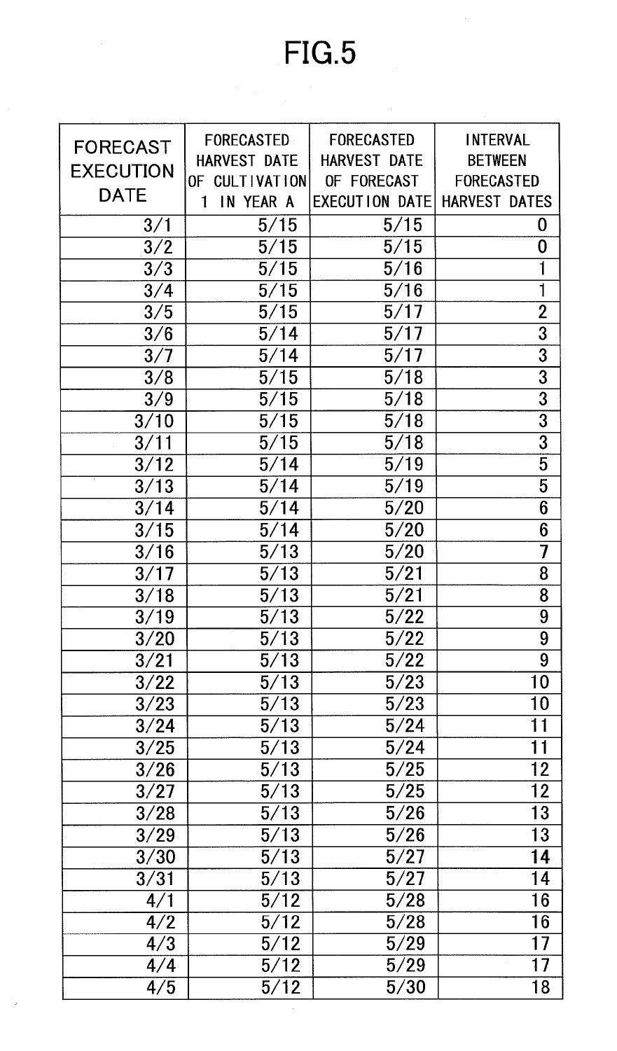

Further, a concrete description follows using FIG. 5. FIG. 5 is a schematic view illustrating an example of the determination method of planting dates of cultivations in year A. It is assumed that planting is done on March 1st for cultivation 1 as planned.

In FIG. 5, forecast execution dates after March 1st, or the planting date of cultivation 1, are listed along with forecast harvest dates of cultivation 1 in year A, forecast harvest dates of forecast execution dates, and intervals between the forecast harvest dates for cultivation 1.

A forecast execution date is a day on which calculation of a forecast harvest date is executed. A forecast harvest date of cultivation 1 in year A is the forecast harvest date of cultivation 1 that has planting date of March 1st in year A. A forecast harvest date of forecast execution date is a forecast harvest date assuming that the very day of the forecast execution date is set as the planting date. An interval between forecast harvest dates for cultivation 1 is the number of days in an interval between a forecast harvest date of cultivation 1 in year A and a forecast harvest date of the forecast execution date.

In FIG. 5, for a forecast execution date of March 16th, the forecast harvest date of cultivation in year A is May 13th, and the forecast harvest date of the forecast execution date is May 20th. Therefore, the interval between the forecast harvest dates for cultivation 1 is seven days. Namely, for each day after March 1st, by calculating the forecast harvest date of cultivation 1 and the forecast harvest date assuming the day as the planting date, an interval longer than or equal to seven days is first detected on March 16th being assumed as the planting date. Seven days is the number of days specified as the harvest interval between cultivation 1 and cultivation 2 in cultivation plan A. Consequently, March 16th is determined as the planting date of cultivation 2.

Similarly, for a forecast execution date of March 30th, the forecast harvest date of cultivation 1 in year A is May 13th, and the forecast harvest date of the forecast execution date is May 27th. Therefore, the interval between the forecast harvest dates for cultivation 1 is 14 days. Namely, for each day after March 1st, calculating the forecast harvest date of cultivation 1 and the forecast harvest date assuming the day as the planting date, an interval longer than or equal to 14 days is first detected on March 30th being assumed as the planting date. Here, days is the number of days specified as the harvest interval between cultivation 1 and cultivation 3 in cultivation plan A. Consequently, March 30th is determined as the planting date of cultivation 3.

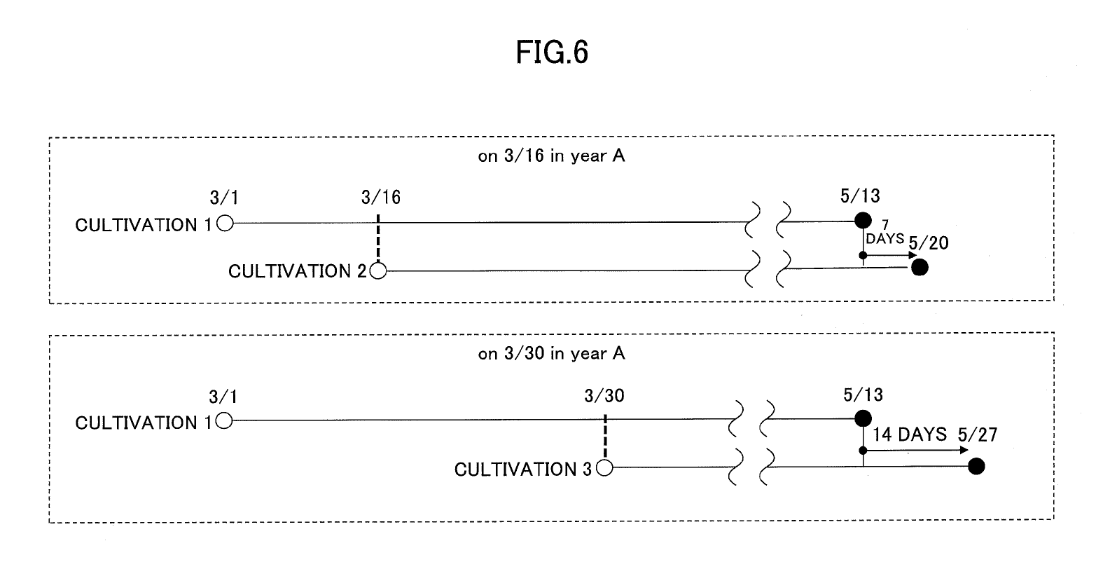

Thus, the planting dates and forecast harvest dates of cultivation 2 or cultivation 3 on March 16th and March 30th, respectively, can be represented as in FIG. 6.

FIG. 6 is a schematic view illustrating the planting dates and forecast harvest dates of cultivation 2 and cultivation 3 in year A. The planting dates are designated by white circles, and the harvest dates are designated by black circles in FIG. 6.

On March 16th in year A, March 16th is determined as the planting date of cultivation 2 because the forecast harvest date of cultivation 1 is calculated as May 13th, and the forecast harvest date of cultivation 2 is calculated as May 20th, which is seven days after the forecast harvest date of cultivation 1.

Also, on March 30th, March 30th is determined as the planting date of cultivation 3 because the forecast harvest date of cultivation 1 is calculated as May 13th, and the forecast harvest date of cultivation 3 is calculated as May 27th, which is days after the forecast harvest date of cultivation 1.

For reference, a case will be described where cultivation plan A is carried out in year B, in which temperatures change differently from those in year A. Assume that year A is a year in which temperatures in March are relatively higher than in the normal year, and year B is a year in which temperatures in March are relatively lower than in the normal year.

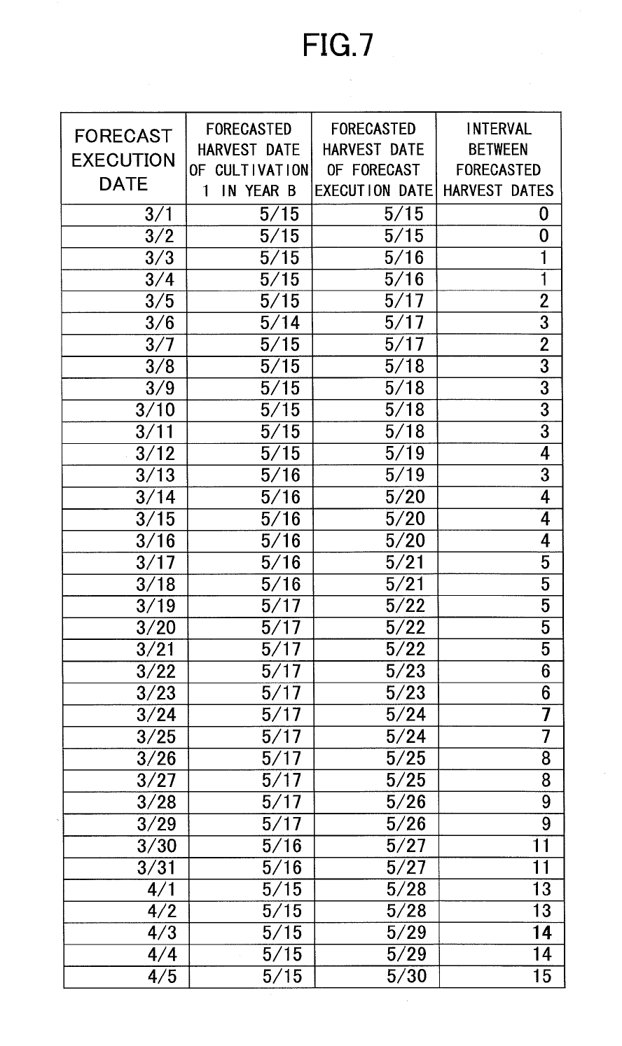

FIG. 7 is a schematic view illustrating an example of a determination method of planting dates of cultivations in year B. In FIG. 7, the same columns are provided as in FIG. 5 except that the column for year A is replaced with that for year B.

In FIG. 7, for a forecast execution date of March 24th, the forecast harvest date of cultivation in year B is May 17th, and the forecast harvest date of the forecast execution date is May 24th. Therefore, the interval between the forecast harvest dates for cultivation 1 is seven days. Consequently, March 24th is determined as the planting date of cultivation 2.

Similarly, in FIG. 7, for a forecast execution date of April 3rd, the forecast harvest date of cultivation 1 in year B is May 15th, and the forecast harvest date of the forecast execution date is May 29th. Therefore, the interval between the forecast harvest dates for cultivation 1 is 14 days. Consequently, April 3rd is determined as the planting date of cultivation 3.

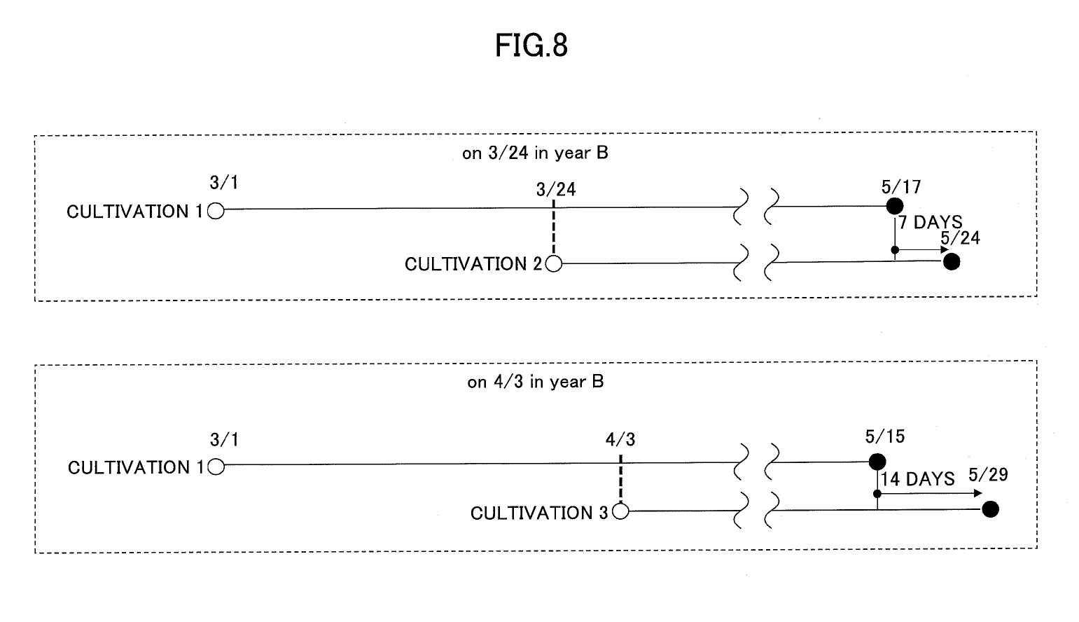

Thus, the planting dates and forecast harvest dates of cultivation 2 or cultivation 3 on March 24th and April 3rd, respectively, can be represented as in FIG. 8.

FIG. 8 is a schematic view illustrating planting dates and forecast harvest dates of cultivation 2 and cultivation 3 in year B. The planting dates are designated by white circles, and the harvest dates are designated by black circles in FIG. 8.

On March 24th in year B, March 24th is determined as the planting date of cultivation 2 because the forecast harvest date of cultivation 1 is calculated as May 17th, and the forecast harvest date of cultivation 2 is calculated May 24th, which is seven days after the forecast harvest date of cultivation 1.

Also, on April 3rd, April 3rd is determined as the planting date of cultivation 3 because the forecast harvest date of cultivation 1 is calculated as May 15th, and the forecast harvest date of cultivation 3 is calculated May 29th, which is 14 days after the forecast harvest date of cultivation 1.

In the case of year B, the planting dates of cultivation 2 and cultivation 3 are later than the corresponding dates in year A because the temperatures in March are relatively lower than in the normal year.

In this way, planting dates can be determined to be fit with change of temperatures in a specific year according to the present embodiment.

Next, a computer will be described that executes the determination method of described planting date described above.

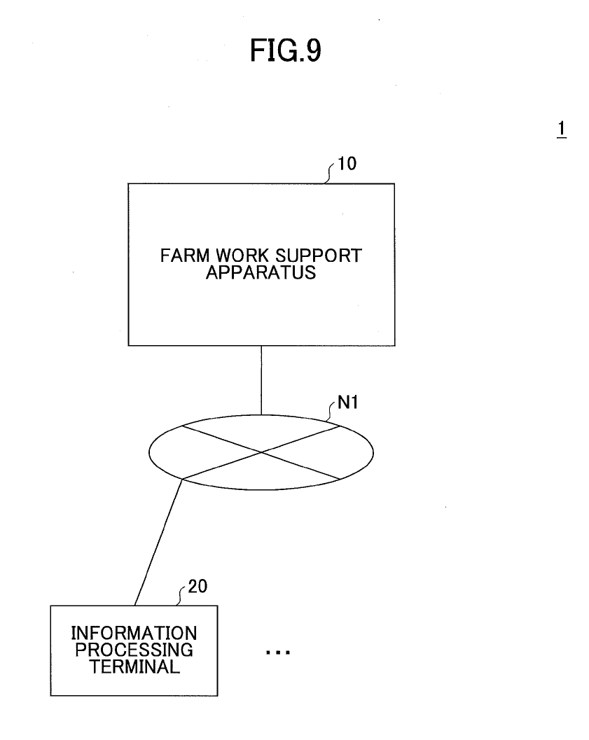

FIG. 9 is a schematic view illustrating an example of a configuration of a farm work support system according to present embodiment. In the farm work support system 1 illustrated in FIG. 9, a farm work support apparatus 10 and an information processing terminal 20 can communicate with each other via a network N1, for example, a LAN (Local Area Network) or the Internet. A part of or all of the network N1 may use wireless communication.

The farm work support apparatus 10 determines planting dates of cultivations in a cultivation plan by the above method. The information processing terminal 20 transmits input information to the farm work support apparatus 10, and displays a processed result from the farm work support apparatus 10. The input information to the farm work support apparatus 10 is entered by, for example, a farm worker on the information processing terminal 20. Information representing a cultivation plan is an example of the input information. Also, a determination result of planting dates of cultivations is an example of the processed result from the farm work support apparatus 10.

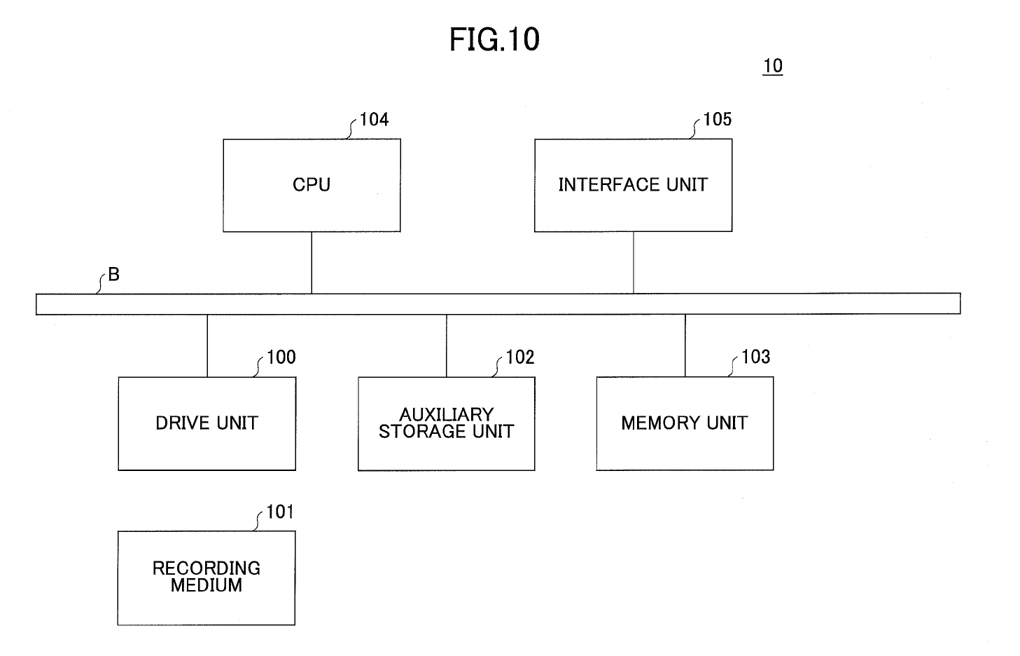

FIG. 10 is a schematic view illustrating an example of a hardware configuration of the farm work support apparatus 10 according to the present embodiment. The farm work support apparatus 10 in

FIG. 10 includes a drive unit 100, an auxiliary storage unit 102, a memory unit 103, a CPU 104, and an interface unit 105, which are mutually connected by a bus B.

A program that performs processing on the farm work support apparatus 10 is provided with a recording medium 101. When the recording medium 101 storing the program is set in the drive unit 100, the program is installed into the auxiliary storage unit 102 from the recording medium 101 via the drive unit 100. However, installation of the program is not necessarily executed from the recording medium 101, but the program may be downloaded from another computer via a network. The auxiliary storage unit 102 stores the installed program, and stores required files, data, and the like as well.

The memory unit 103 reads the program from the auxiliary storage unit 102 to store the program into it when receiving a start command for the program. The CPU 104 implements functions relevant to the farm work support apparatus 10 by executing the program stored in the memory unit 103. The interface unit 105 is used as an interface for connecting with a network.

Note that an example of the recording medium 101 may be a CD-ROM, a DVD disk, or a portable recording medium such as a USB memory. Also, an example of the auxiliary storage unit 102 may be an HDD (Hard Disk Drive), a flash memory, or the like. Both the recording medium 101 and the auxiliary storage unit 102 correspond to computer-readable recording media.

Note that the farm work support apparatus may be connected with a display unit and/or a input unit such as a keyboard and a mouse.

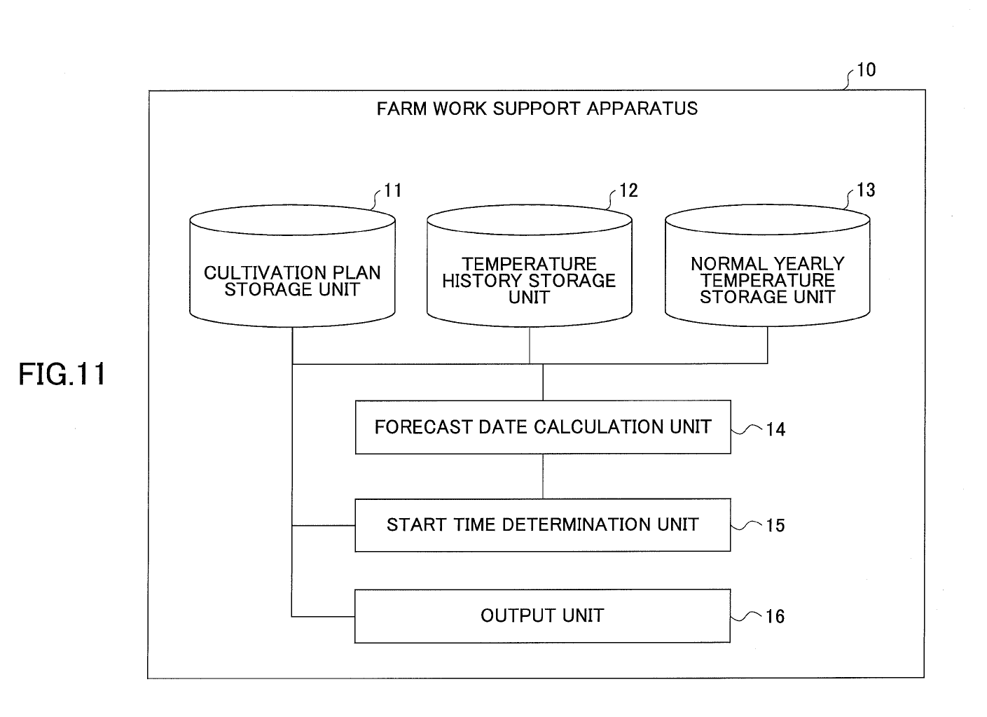

FIG. 11 is a schematic view illustrating an example of a functional configuration of the farm work support apparatus 10 according to the present embodiment. In FIG. 11, the farm work support apparatus 10 utilizes a cultivation schedule storage unit 11, a temperature history storage unit 12, a normal yearly temperature storage unit 13, and the like. These storage units may be implemented by the auxiliary storage unit 102 or a storage device connected with the farm work support apparatus 10 via a network.

The cultivation schedule storage unit 11 stores information that represents a cultivation schedule. The information that represents a cultivation schedule is referred to as the “cultivation schedule information” in the following. The cultivation schedule information includes, for example, a planting date of a cultivation that is the first planting date among multiple cultivations included in a cultivation plan, harvest intervals between the cultivation and the other cultivations, and the effective accumulated temperature in the harvest season of crops to be cultivated.

The temperature history storage unit 12 stores a history of temperatures. A history of temperatures includes a history of result values of average temperatures of days, at least the days after the planting date of the first cultivation. The history of temperatures stored in the temperature history storage unit 12 is updated, for example, every day. Namely, a result value of an average temperature for a day that has newly passed is stored in the temperature history storage unit 12. The normal yearly temperature storage unit 13 stores normal yearly temperature information. The normal yearly temperature information includes, for example, normal yearly values of average temperatures of days during a year.

The farm work support apparatus 10 also includes a forecast date calculation unit 14, a start time determination unit 15, and an the output unit 16. These units are implemented by procedures that a program installed in the farm work support apparatus 10 has the CPU 104 execute.

The forecast date calculation unit 14 calculates a forecast harvest date for each cultivation based on the cultivation plan information, the temperature history information, and the normal yearly temperature information.

The start time determination unit 15 determines a start time for each cultivation based on a calculation result of the forecast date calculation unit 14. In the present embodiment, planting dates of the cabbage M are determined.

The output unit 16 outputs a planting execution command on a planting date determined by the start time determination unit 15.

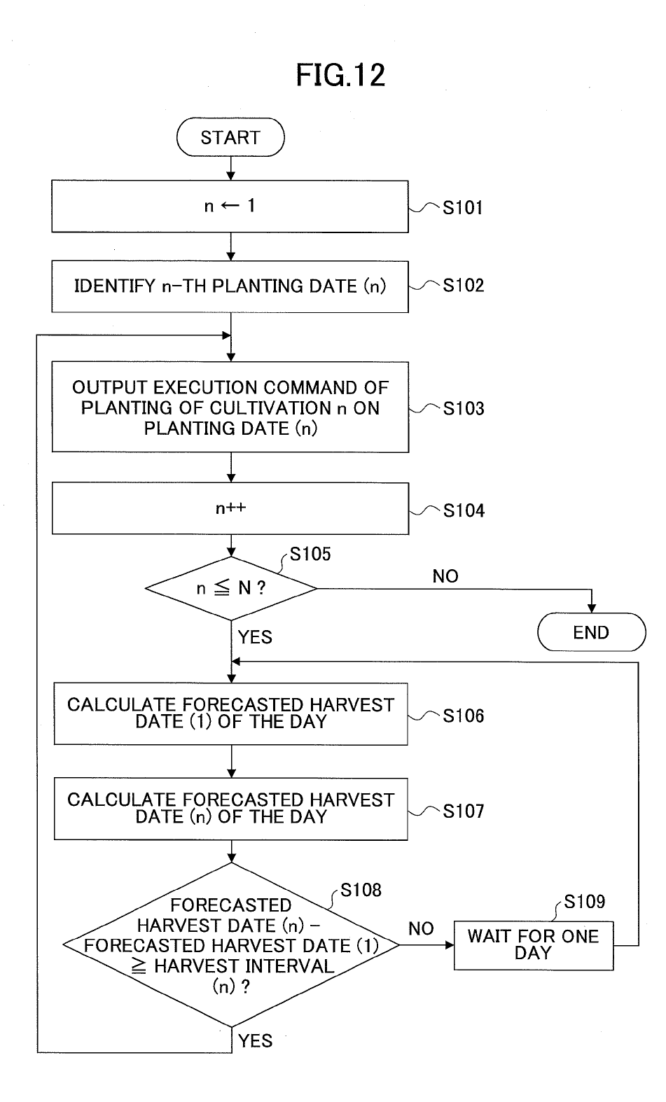

In the following, a process will be described that is executed by the farm work support apparatus 10. FIG. 12 is a flowchart illustrating an example of a determination process of planting dates.

At Step S101, the output unit 16 sets 1 to a variable n. The variable n is a variable representing an order of cultivations whose planting dates are to be determined. Here, by setting 1 to the variable n, the planting date of a first cultivation is to be determined. Note that cultivations in a cultivation plan are ordered so that a cultivation whose planting date has been determined comes first, followed by the other cultivations in ascending order of lengths of harvest intervals with the harvest date of the first cultivation. Note that the n-th cultivation is referred to as “cultivation n” in the following description.

Next, the output unit 16 identifies the planting date of cultivation 1 with reference to the cultivation plan storage unit 11 (Step S102). Namely, the planting date of cultivation 1 stored in the cultivation plan storage unit 11 is obtained. Next, the output unit 16 outputs a planting execution command for the planting date of cultivation 1 (Step S103). The planting execution command may be indicated to the information processing terminal 20, for example, by electronic mail, or may be sent back to the information processing terminal 20 in response to a query. Alternatively, if a display unit is connected with the farm work support apparatus 10, it may be displayed on the display unit. Also, Step S103 may be executed after waiting for the planting date of cultivation 1, or may be executed before the planting date. If executed before the planting date, the planting date is also output.

Next, the output unit 16 adds 1 to n (Step S104). Next, the output unit 16 determines whether n is less than or equal to N (Step S105). N is the total number of cultivations included in the cultivation plan. Namely, at Step S105, it is determined whether there are any cultivations whose planting dates are yet to be determined among the cultivations included in the cultivation plan.

If n is less than or equal to N (YES at Step S105), the forecast date calculation unit 14 calculates forecast harvest date (1) of cultivation 1 on the day (Step S106). Also, the forecast date calculation unit 14 calculates forecast harvest date (n) of cultivation 1 on the day (Step S107). Note that the day is a day when Step S106 or S107 is executed. Namely, the day is a current day. Note that the calculation method of forecast harvest dates is as described earlier. Namely, for the effective accumulated temperature up to the day, result values are used that are stored in the temperature history storage unit 12. Also, for the effective accumulated temperature after the day, normal yearly values are used that are stored in the normal yearly temperature storage unit 13. The next day of a day when the effective accumulated temperature becomes greater than or equal to the effective accumulated temperature that corresponds to the harvest date stored in the cultivation plan storage unit 11 is determined as the forecast harvest date.

Next, the start time determination unit 15 determines whether (forecast harvest date (n)—forecast harvest date (1)) is greater than or equal to harvest interval (n) (Step S108). Namely, it is determined whether the interval, or difference, between the forecast harvest date of cultivation n and the forecast harvest date of cultivation 1 is greater than or equal to the harvest interval between cultivation n and cultivation 1 in the cultivation plan.

If the condition at Step S108 is not satisfied (NO at Step S108), the farm work support apparatus 10 waits for one day before proceeding with the process in FIG. 12 (Step S109). For example, the process in FIG. 12 is kept in a wait state until a predetermined time on the next day comes. After the wait state is released, Steps S106 to S108 are repeated.

If the condition at Step S108 is satisfied (YES at Step S108), the output unit 16 determines that the day is the planting date of cultivation n. Namely, it is determined that the current day is the planting date. Thereupon, the output unit 16 executes Step S103 for cultivation n. Next, Steps S104 and after are repeated. Then, when n exceeds N, namely, when the planting dates are determined for all cultivations included in the cultivation plan (NO at Step S105), the process in FIG. 12 ends.

Note that although an example is described with FIG. 12 where Steps S106 to S108 are repeated every day, the wait time at Step S109 may not necessarily be one day. For example, the wait time may be two days or any other durations. However, everyday repetition has an advantage in that likelihood is high for determining a planting date with which a harvest interval closer to that in the cultivation plan is obtained.

Also, Steps S106 to S109 may not be actively repeated by the farm work support apparatus 10. For example, the process in FIG. 12 may be executed in response to an input command entered by a user at a timing convenient for the user. In this case, if it is determined YES at Step S108, information may be stored in, for example, the auxiliary storage unit 102, that can distinguish cultivations whose planting dates have already been determined from cultivations whose planting dates are yet to be determined. When the process in FIG. 12 is executed next time, the steps may be executed by setting a cultivation having the shortest harvest interval with cultivation 1 as cultivation n among the cultivations whose planting dates are yet to be determined.

Also note that although the examples in the present embodiment use the effective accumulated temperature for calculating forecast harvest dates, forecast harvest dates may be calculated by other methods. Other parameters, for example, hours of sunshine and DVI (Development Index or growth index) values may be taken into consideration.

Also, values used as forecast values may not necessarily be normal yearly values. For example, result values of a year having similar weather condition changes after cultivation 1 may be used as forecast values.

Also, although cultivation schedule A is taken as an example where crops of the same breed are planted on shifted dates in the present embodiment, breeds of crops of cultivations included in a cultivation schedule may be different from each other.

Also, cultivations included in a cultivation schedule may not be carried out in the same region. If cultivations are carried out in regions that are mutually different, the temperature history storage unit 12 and the normal yearly temperature storage unit 13 may be provided for each of the regions. The process in FIG. 12 may be executed using the temperature history storage unit and the normal yearly temperature storage unit 13 provided for each of the regions for the cultivations.

Also, the present embodiment may be applied to a cultivation schedule that requires forecast harvest dates of the cultivations to coincide with each other.

Also, although an example is illustrated where planting dates are determined in the present embodiment, a cultivation may not necessarily be started with planting for other crops. For example, for crops whose cultivation is started with seeding, seeding dates may be determined. Namely, a planting date is an example of a cultivation start date.

As described above, a forecast harvest date for a second cultivation or after is calculated by using result values of a weather condition from the start time of the first cultivation to the day according to the present embodiment. Therefore, a forecast value can be obtained that takes the weather condition of a year of cultivation into consideration, for the cultivation interval between the start time of the first cultivation and the start time of the second cultivation or after. By setting a day as a start time of a next cultivation that makes the forecast value of the harvest interval greater than or equal to a planned harvest interval, likelihood can be raised to suppress deviation from the plan in terms of intervals of harvest times of multiple cultivations. Consequently, a farm worker can carry out harvest in a state where intervals of harvest times of cultivations are evenly arranged.

Note that the forecast date calculation unit 14 is an example of a calculation unit in the present embodiment. The start time determination unit 15 is an example of a determination unit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A farm work support method executed by a computer, the method comprising:
calculating a forecast harvest date of a first cultivation of crops based on result values of a weather condition from a start date of the first cultivation to a current day stored in a storage unit, and forecast values of the weather condition after the current day stored in the storage unit, and calculating a forecast harvest date of a second cultivation of crops based on the forecast values after the current day stored in the storage unit; and
determining the current day as a start date of the second cultivation if an interval between the forecast harvest date of the first cultivation and the forecast harvest date of the second cultivation has the number of days greater than or equal to a predetermined number of days.

2. The farm work support method as claimed in claim 1, wherein the calculating of the forecast harvest date of the first cultivation calculates the forecast harvest date of the first cultivation based on result values of effective accumulated temperatures from the start date of the first cultivation to the current day stored in the storage unit, and forecast values of the effective accumulated temperatures after the current day stored in the storage unit.

3. The farm work support method as claimed in claim 1, wherein the calculating of the forecast harvest date of the first cultivation periodically calculates the forecast harvest date of the first cultivation,
wherein the calculating of the forecast harvest date of the second cultivation calculates the forecast harvest date of the second cultivation every time the forecast harvest date of the first cultivation is calculated.

4. A farm work support apparatus comprising:
a storage unit; and
a processor configured to calculate a forecast harvest date of a first cultivation of crops based on result values of a weather condition from a start date of the first cultivation to a current day stored in the storage unit, and forecast values of the weather condition after the current day stored in the storage unit, and to calculate a forecast harvest date of a second cultivation of crops based on the forecast values after the current day stored in the storage unit, and
to determine the current day as a start date of the second cultivation if an interval between the forecast harvest date of the first cultivation and the forecast harvest date of the second cultivation has the number of days greater than or equal to a predetermined number of days.

5. A system comprising:
a farm work support apparatus including
a storage unit and
a processor configured to calculate a forecast harvest date of a first cultivation of crops based on result values of a weather condition from a start date of the first cultivation to a current day stored in the storage unit, and forecast values of the weather condition after the current day stored in the storage unit, and to calculate a forecast harvest date of a second cultivation of crops based on the forecast values after the current day stored in the storage unit, and
to determine the current day as a start date of the second cultivation if an interval between the forecast harvest date of the first cultivation and the forecast harvest date of the second cultivation has the number of days greater than or equal to a predetermined number of days; and
an information processing apparatus configured to communicate with the farm work support apparatus via a network, for transmitting input information to the farm work support apparatus, and displaying a processed result from the farm work support apparatus.
